(19) United States
(12) Patent Application Publication
(10) Pub. No.: US 2005/0273486 A1
(43) Pub. Date: Dec. 8, 2005

(54) Virtual distributed file system

(76) Inventor: Robert O. Keith JR., Modesto, CA (US)

Correspondence Address: HAVERSTOCK & OWENS LLP, 162 NORTH WOLFE ROAD, SUNNYVALE, CA, 94086, US

(21) Appl. No.: 10/912,652

(22) Filed: Aug. 4, 2004

Related U.S. Application Data
(60) Provisional application No. 60/577,148, filed on Jun. 3, 2004.

(51) Int. Cl. G06F 15/16

(52) U.S. Cl. 709/200

(57) ABSTRACT

A virtual distributed file system for executing applications from a remote location comprises an application server for remotely storing an original copy of the applications, and a client computing device which contains an operating system for executing the applications, a communications interface configured for communicating with the application server, a virtual file system mapped to a remote file system located on the application server, and a ring buffer cache for storing the applications on the computing device. If the modules are not found locally, the modules are transferred from the application server. The computing device is from a group consisting of a thin client, personal computer, laptop or PDA. The applications are segmented into compressed modules when transferred. The ring buffer is pre-seeded with compressed modules. The computing device is usable online or offline a network. A movable profile is accessible by a user from a plurality of computing devices.

### RELATED APPLICATIONS

This patent Application claims priority under 35 U.S.C. 119(e) of the co-pending U.S. Provisional Patent Application Ser. No. 60/577,148, filed Jun. 3, 2004, and entitled “VIRTUAL MANAGEMENT SYSTEM”. The Provisional Patent Application Ser. No. 60/577,148 filed Jun. 3, 2004, and entitled “VIRTUAL MANAGEMENT SYSTEM” is also hereby incorporated by reference.

### FIELD OF THE INVENTION

The present invention relates to the field of file systems. More specifically, the present invention relates to a distributed file system for loading an application from a server onto a client.

### BACKGROUND OF THE INVENTION

In the past, the process of installing and updating applications as well as sharing information on a plurality of computers was arduous and time-consuming. Professionals would install software on each computer using compact discs (CDs), network shares or other similar methods. As mentioned, this is time-consuming as well as difficult to synchronize throughout an entire company. With the advent of the computer networking, where a plurality of computers communicate together, the process became much more streamlined. Specifically, two techniques for delivering applications have been developed over the years, remote execution and local delivery.

In a remote execution embodiment, a user accesses software which is loaded and executed on a remote server under the control of the user. One example is the use of Internet-accessible CGI programs which are executed by Internet servers based on data entered by a client. A more complex system is the Win-to-Net system provided by Menta Software. This system delivers client software to the user which is used to create a Microsoft® Windows® style application window on the client machine. The client software interacts with an application program executing on the server and displays a window which corresponds to one which would be shown if the application were installed locally. The client software is further configured to direct certain I/O operations, such as printing a file, to the client's system, to replicate the “feel” of a locally running application. Other remote-access systems, such as provided by Citrix Systems, are accessed through a conventional Internet Browser or a proprietary client and present the user with a “remote desktop” generated by a host computer which is used to execute the software.

Since the applications are already installed on the server system, remote execution permits the user to access the programs without transferring a large amount of data. However, this type of implementation requires the supported software to be installed on the server. Thus, the server must utilize an operating system which is suitable for the hosted software. In addition, the server must support separately executing program threads for each user of the hosted software. For complex software packages, the necessary resources can be significant, limiting both the number of concurrent users of the software and the number of separate applications which can be provided.

In a local delivery embodiment, the desired application is packaged and downloaded to the user's computer. Preferably, the applications are delivered and installed as appropriate using automated processes. After installation, the application is executed. Various techniques have been employed to improve the delivery of software, particularly in the automated selection of the proper software components to install and initiation of automatic software downloads. In one technique, an application program is broken into parts at natural division points, such as individual data and library files, class definitions, etc., and each component is specially tagged by the program developer to identify the various program components, specify which components are dependent upon each other, and define the various component sets which are needed for different versions of the application.

Once such tagging format is defined in the Open Software Description (“OSD”) specification, jointly submitted to the World Wide Web Consortium by Marimba Incorporated and Microsoft Corporation on Aug. 13, 1999. Defined OSD information can be used by various “push” applications or other software distribution environments, such as Marimba's Castanet product, to automatically trigger downloads of software and ensure that only the needed software components are downloaded in accordance with data describing which software elements a particular version of an application depends on.

Although on-demand local delivery and execution of software using OSD/push techniques is feasible for small programs, such as simple Java applets, for large applications, the download time can be prohibitively long. Thus, while suitable for software maintenance, this system is impractical for providing local application services on-demand because of the potentially long time between when the download begins and the software begins local execution.

In the more recent past, attempts have been made to use streaming technology to deliver software to permit an application to begin executing before it has been completely downloaded. Streaming technology was initially developed to deliver audio and video information in a manner which allowed the information to be output without waiting for the complete data file to download. For example, a full-motion video can be sent from a server to a client as a linear stream of frames instead of a complete video file. As each frame arrives at the client, it can be displayed to create a real-time full-motion video display. However, unlike the linear sequences of data presented in audio and video, the components of a software application can be executed in sequences which vary according to user input and other factors.

To address the deficiencies in prior data streaming and local software delivery systems, an improved technique of delivering applications to a client for local execution has been developed. This technique called “Streaming Modules” is described in U.S. Pat. No. 6,311,221 to Raz et al. In a particular embodiment of the “Streaming Modules” system, a computer application is divided into a set of modules, such as the various Java classes and data sets which comprise a Java applet. Once an initial module or modules are delivered to the user, the application begins to execute while additional modules are streamed in the background. The modules are streamed to the user in an order which is selected to deliver the modules before they are required by the locally executing software. The sequence of streaming can be varied in response to the manner in which the user operates the application to ensure that needed modules are delivered prior to use as often as possible. To reduce streaming time, the size of code files, such as library modules, can be reduced by substituting various coded procedures with shortened streaming “stub” procedures which act as link-time substitutes for the removed code. Suitable modules to replace are those which are not required for the initial execution of the application. As the application is running locally on the client, additional modules are streamed to the client and the stub code can be dynamically replaced as the substituted procedures are received. The stub procedure can point to a streaming engine which will request a missing procedure if the program calls it before it has been received at the client. Although effective, the stub-code substitution technique used in the “Streaming Modules” system may require a reasonable degree of processing to prepare a given application for streaming. In addition, the client software required to manage the streamed modules does not necessarily integrate cleanly with the normal routines used by the operating system executing on the client machine.

To remedy some of the remaining issues, U.S. Pat. No. 6,574,618 to Eylon et al. disclosed a method and system for executing network streamed applications. Within the system, a client computer executes an application while parts of the application code are still being retrieved from the server over a network. The additional components of the application which were not required for startup are continuously loaded in the background until the entire application resides on the client computer. There are a number of drawbacks with this system though. The client cannot function without the server being available. Although, the application is physically available on the client once downloaded, due to encryption or other proprietary methods of preventing unauthorized access, the application is unavailable. Furthermore, the prior art does not permit a user to access the server and applications from multiple client locations. Hence, an improved system is required to handle all of these issues as well as present features not yet discussed.

### SUMMARY OF THE INVENTION

A virtual distributed file system for executing applications from a remote location comprises an application server for remotely storing an original copy of the applications, and a client computing device which contains an operating system for executing the applications, a communications interface configured for communicating with the application server, a virtual file system mapped to a remote file system located on the application server, and a ring buffer cache for storing the applications on the computing device. If the modules are not found locally, the modules are transferred from the application server. The computing device is from a group including but not limited to a thin client, personal computer, laptop, PDA, or consumer electronic device such as a television, robot or camera. The applications are segmented into compressed modules when transferred. The ring buffer is pre-seeded with compressed modules. The computing device is usable online or offline a network. A movable profile is accessible by a user from a plurality of computing devices.

In one aspect of the present invention, a system for locally executing one or more applications transferred from a remote location comprises an application server for remotely storing the one or more applications, and a computing device contains a first operating system for executing the one or more applications, a communications interface configured for communicating with the application server, a first virtual file system mapped to a remote file system located on the application server, and a ring buffer cache for storing one or more modules of the one or more applications on the computing device. The computing device is from a group consisting of a thin client, personal computer, laptop, PDA or a consumer electronic device. The one or more applications are segmented into one or more compressed modules. A main module of the one or more applications is transferred so that the application is executable nearly immediately, followed by one or more compressed modules related to the main module. A determination of the one or more compressed modules related to the main module is determined by statistical approximations or on demand. The computing device is usable either online or offline a network. The one or more applications are fully installed for offline functionality. The system further comprises a movable profile whereby a second virtual file system is accessible from a plurality of computing devices by a user. The system further comprises licensing and subscription capabilities. The application server contains a second operating system which is different from the first operating system contained in the computing device. The one or more applications are updated using sliding cyclic redundancy code (CRC) transfer protocol. The ring buffer cache is pre-seeded with one or more compressed modules. Pipelining is utilized to transfer the one or more applications. The first operating system contained in the computing device communicates with the first virtual file system as if the first virtual file system were a local storage device. The first operating system retrieves one or more modules from the first virtual file system by either determining that the one or more modules is present locally or by requesting a transfer of the one or more modules from the application server. The system further comprises a network for coupling the application server to the computing device, and the network for transferring the one or more applications from the application server to the computing device.

In another aspect of the present invention, a system for locally executing one or more applications transferred from a remote location comprises an application server for remotely storing the one or more applications, and a computing device which contains a first operating system for executing the one or more applications while online or offline, a communications interface configured for communicating with the application server, a first virtual file system mapped to a remote file system located on the application server, and a ring buffer cache for storing the one or more applications on the computing device wherein the application server maintains a movable profile corresponding to a user, which is accessible from a plurality of remote computing devices. The computing device is from a group consisting of a thin client, personal computer, laptop, PDA or a consumer electronic device. The one or more applications are fully installed for offline functionality. The system further comprises licensing and subscription capabilities. The application server contains a second operating system which is different from the first operating system contained in the computing device. The one or more applications are updated using sliding CRC transfer protocol. The ring buffer cache is pre-seeded with a second set of one or more compressed modules. Pipelining is utilized to transfer the one or more applications. The first operating system located on the computing device communicates with the first virtual file system as if the first virtual file system were a local storage device. The first operating system retrieves one or more modules from the first virtual file system by either determining that the one or more modules is present locally or by requesting a transfer of the one or more modules from the application server. The system further comprises a network for coupling the application server to the computing device, and the network for transferring the one or more applications segmented into a first set of one or more compressed modules from the application server to the computing device, further wherein a main module is transferred so that the application is executable nearly immediately, followed by the first set of modules related to the main module.

In yet another aspect of the present invention, a method of locally executing one or more applications transferred from a remote location comprises storing the one or more applications on an application server, mapping a first virtual file system located on a computing device to a remote file system located on the application server, storing one or more modules of the one or more applications in a ring buffer cache on the computing device, and executing the one or more applications on the computing device containing a first operating system. The computing device is from a group consisting of a thin client, personal computer, laptop, PDA or a consumer electronic device. The one or more applications are segmented into one or more compressed modules. A main module of the one or more applications is transferred so that the application is executable nearly immediately, followed by one or more compressed modules related to the main module. A determination of the one or more compressed modules related to the main module is determined by statistical approximations or on demand. The computing device is usable either online or offline a network. The one or more applications are fully installed for offline functionality. The method further comprises accessing a second virtual file system from a plurality of computing devices by a user with a movable profile. The method further comprises licensing and subscription capabilities. The application server contains a second operating system which is different from the first operating system contained in the computing device. The method further comprises updating the one or more applications using sliding cyclic redundancy code (CRC) transfer protocol. The method further comprises pre-seeding the ring buffer cache with one or more compressed modules. The method further comprises pipelining to transfer the one or more applications. The first operating system contained in the computing device communicates with the first virtual file system as if the first virtual file system were a local storage device. The first operating system retrieves the one or more modules from the first virtual file system by either determining that the one or more modules is present locally or by requesting a transfer of the one or more modules from the application server. The method further comprises transferring the one or more applications from the application server to the computing device through a network which couples the application server to the computing device. The method further comprises transferring the one or more modules from the application server to the ring buffer cache.

In another aspect of the present invention a method of locally executing one or more applications transferred from a remote location comprises remotely storing the one or more applications on an application server, mapping a first virtual file system located on a computing device to a remote file system located on the application server, storing one or more modules of the one or more applications in a ring buffer cache on the computing device, executing the one or more applications on the computing device containing a first operating system while online or offline the network and establishing a movable profile corresponding to a user, which is accessible from a plurality of remote computing devices. The computing device is from a group consisting of a thin client, personal computer, laptop, PDA or a consumer electronic device. The one or more applications are fully installed for offline functionality. The method further comprises licensing and subscription capabilities. The application server contains a second operating system which is different from the first operating system contained in the computing device. The method further comprises updating the one or more applications using sliding CRC transfer protocol. The method further comprises pre-seeding the ring buffer cache with one or more compressed modules. The method further comprises pipelining to transfer the one or more applications. The first operating system located on the computing device communicates with the first virtual file system as if the first virtual file system were a local storage device. The first operating system retrieves the one or more modules from the first virtual file system by either determining that the one or more modules is present locally or by requesting a transfer of the one or more modules from the application server. The method further comprises transferring the one or more applications segmented into a first set of one or more compressed modules from the application server to the computing device through a network which couples the application server to the computing device, further transferring a main module so that the application is executable nearly immediately, followed by the first set of modules related to the main module. The method further comprises transferring the one or more modules from the application server to the ring buffer cache.

In yet another aspect of the present invention, a method of locally executing an application transferred from a remote location comprises remotely storing the application on an application server, mapping a first virtual file system located on a computing device to a remote file system located on the application server, determining if one or more modules of the application are located within a ring buffer cache, retrieving the one or more modules from the ring buffer cache if it is determined that the one or more modules are located within the ring buffer cache, transferring the one or more modules from the application server to the computing device, and storing the one or more modules in the ring buffer cache on the computing device if it is determined that the one or more modules are not located within the ring buffer cache, executing the application on the computing device containing a first operating system while online or offline the network, and establishing a movable profile corresponding to a user, which is accessible from a plurality of remote computing devices. The computing device is from a group consisting of a thin client, personal computer, laptop, PDA or a consumer electronic device. The application is fully installed for offline functionality. The method further comprises licensing and subscription capabilities. The application server contains a second operating system which is different from the first operating system contained in the computing device. The method further comprises updating the application using sliding CRC transfer protocol. The method further comprises pre-seeding the ring buffer cache with one or more compressed modules. The method further comprises pipelining to transfer the one or more modules. The first operating system located on the computing device communicates with the first virtual file system as if the first virtual file system were a local storage device. The method wherein the transferring occurs through a network. The application is segmented into a first set of one or more compressed modules. The method further comprises transferring a main module so that the application is executable nearly immediately followed by a first set of modules related to the main module.

In yet another aspect of the present invention, an apparatus for storing one or more applications on a remote location comprises, a server for distributing the one or more applications as one or more compressed modules to one or more remote computing devices, wherein the server automatically updates the one or more applications on the one or more computing devices, and a file system located on the server for mapping to a virtual file system on the one or more computing devices with a ring buffer cache wherein the one or more computing devices retrieve one or more compressed modules from the server only as necessary. The one or more computing devices are from a group consisting of a thin client, personal computer, laptop, PDA or a consumer electronic device. The apparatus further comprises licensing and subscription capabilities. The application server contains a first operating system which is different from a second operating system contained in the computing device. The one or more applications are updated using sliding CRC transfer protocol. Pipelining is utilized to transfer the one or more applications.

In another aspect of the present invention, an apparatus for retrieving an application from a remote location comprises a computing device, a first operating system for executing the application, a first virtual file system stored on the computing device for mapping to a remote file system stored on an application server wherein the remote file system contains an original copy of the application, and a ring buffer cache for storing one or more modules of the application. The computing device is from a group consisting of a thin client, personal computer, laptop, PDA or a consumer electronic device. The application is segmented into one or more compressed modules. The computing device is usable either online or offline a network. The application is fully installed for offline functionality. The apparatus further comprises a movable profile whereby a second virtual file system is accessible from a plurality of computing devices by a user. The apparatus further comprises licensing and subscription capabilities. The application server contains a second operating system which is different from the first operating system contained in the computing device. The application is updated using sliding cyclic redundancy code (CRC) transfer protocol. The ring buffer cache is pre-seeded with one or more compressed modules. Pipelining is utilized to transfer the application. The first operating system contained in the computing device communicates with the first virtual file system as if the first virtual file system were a local storage device. The first operating system retrieves one or more modules from the first virtual file system by either determining that the one or more modules is present locally or by requesting a transfer of the one or more modules from the application server. The apparatus further comprises a network for coupling the application server to the computing device, wherein the network transfers the application from the application server to the computing device.

Another aspect of the present invention is a data structure for storing one or more applications retrieved from a remote location, wherein the one or more applications are indexed by a local file system, and further wherein the data structure removes the least active files when a buffer size limit is surpassed, and also wherein the data structure is index searchable. The one or more applications are segmented into one or more compressed modules. The structure is index searchable by a full directory path or by a CRC value. The structure is pre-seeded with the one or more applications.

### BRIEF DESCRIPTION OF THE DRAWINGS

FIG. 1 illustrates graphical representation of a virtual distributed file system of the preferred embodiment of the present invention.

FIG. 2 illustrates a flowchart showing an algorithm for local storage mapping of the preferred embodiment of the present invention.

FIG. 3 illustrates a graphical representation of a local directory data structure of the preferred embodiment of the present invention.

FIG. 4a illustrates a flowchart showing an algorithm for a synchronization protocol for mounting a file system of the preferred embodiment of the present invention.

FIG. 4b illustrates a flowchart showing an algorithm for a synchronization protocol for opening a file of the preferred embodiment of the present invention.

FIG. 5 illustrates a graphical representation of a virtual distributed file system directory and a ring buffer cache of the preferred embodiment of the present invention.

FIG. 6a illustrates a flowchart showing an algorithm for inserting a file into a ring buffer cache of the preferred embodiment of the present invention.

FIG. 6b illustrates a flowchart showing an algorithm for deleting a file from a ring buffer cache of the preferred embodiment of the present invention.

FIG. 7 illustrates a graphical representation of physical components of a virtual distributed file system of the preferred embodiment of the present invention.

### DETAILED DESCRIPTION OF A PREFERRED EMBODIMENT

A virtual distributed file system is a group of technologies that enable a personal computer, thin client and other personal computing hardware devices to execute software installed and maintained on a central server system. User software profiles follow a user at network login and allow the user to run the same software defined in his user profile on different hardware devices, increasing the user's flexibility and mobility by removing reliance on a single hardware device. Software is installed and maintained at one location centrally and can be utilized at an almost unlimited number of network locations.

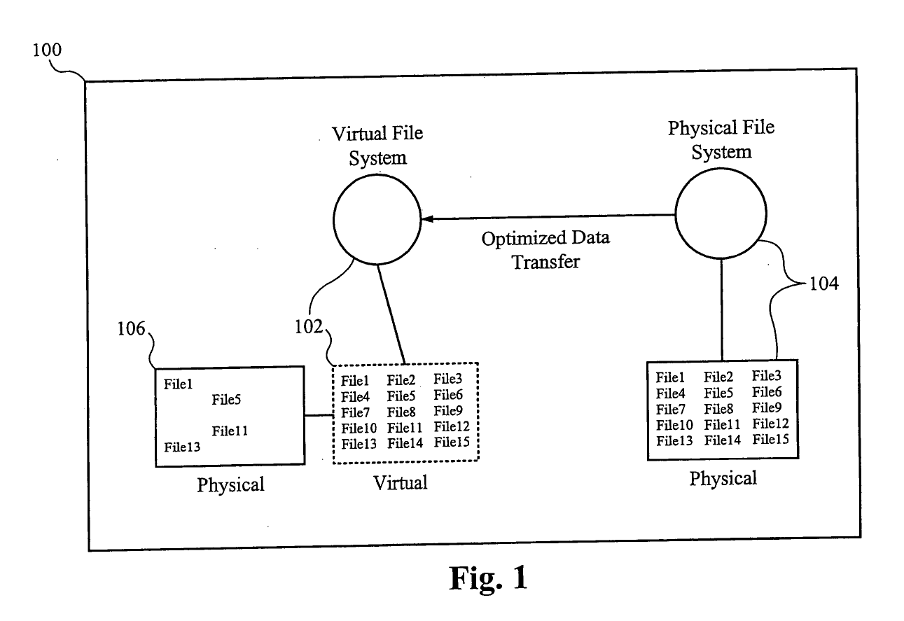

FIG. 1 illustrates a graphical representation of a virtual distributed file system 100 of a preferred embodiment of the present invention. The virtual distributed file system 100 is a technology that creates a local virtual file system 102 that is mapped to a remote physical file system 104. The local virtual file system 102 looks and behaves like other file systems, so that executable programs or other processes which interact with the virtual file system 102 interpret the local virtual file system 102 as a local physical file system 106. Access to a file not available on the local virtual file system 102 suspends the process while a copy of the file is transferred from the remote physical file system 104 to the local virtual file system 102. Then the process opens the file as would occur on a physical file system. The remote physical file system 104 is a master data source, and the local virtual file system 102 is a localized view of the data.

Features of the virtual distributed file system 100 include but are not limited to quick installation, optimized random file access, optimized storage, local file system cache, less reliance on a network, and automatic software updates. The virtual file system 102 is generated quickly because the actual data is stored and retrieved at a later time. For many current applications virtual software installations will happen in less than a second. The software which is downloaded from the remote physical file system 104 is split into many small files which are accessed at different times during the execution of the software. By splitting the software into many small files, the main module of the software is downloaded first. Once installed on the local virtual file system 102, the software is available for use. The other program modules associated with the downloaded program are downloaded only when needed. By installing only a small subset of the modules of the software, much less storage space is required on a client's system. The unused modules remain available on the remote physical file system 104 for any client's needs. By using a localized file system cache, the transfer of the software modules is only required once, since the modules are stored locally and reused. By storing the software modules locally, as soon as a core set of modules are obtained, the local system no longer has to rely on the remote system, aside from any unobtained modules that are needed in the future. For synchronization of software throughout the network of clients and a server, when any module is updated or patched on the remote physical file system 104, the module is re-transferred automatically to the clients. Considering the features of such a system, the virtual distributed file system 100 is best suited for accessing a read-only, relatively static, remote file system, such as an application software file system.

The benefits of the virtual distributed file system 100 include but are not limited to scalability, mobility, supportability, and performance. The virtual distributed file system 100 is scalable because a single server can service thousands of remote users since file transfer occurs infrequently. Typically, to serve thousands of remote users, a server requires expensive hardware including numerous processors, many gigabytes of cache, as well as other proprietary hardware developed by companies like Sun Microsystems and IBM. Furthermore, the bandwidth of the systems is so high that specialized technologies are needed or the congestion will bring the system to a halt. By minimizing the amount of traffic and the number of transactions between the server and the client, the present invention allows for an inexpensive system to function comparably to much more expensive systems. The ability for a user to utilize the virtual distributed file system 100 in a number of different locations without having to spend hours reinstalling software greatly increases the mobility of the system. Since the access of the application data is virtual, the file system and application are generated almost instantly when the user accesses another device. With minimal storage required, “thin” devices are usable within the virtual distributed file system 100. A “thin” device has a very small amount of storage, decreasing the cost of the device, which is extremely important for a company or school requiring hundreds or thousands of devices, but limited in financial resources. The “thin” device has the ability to run large applications while still using very little storage. Wide Area Networks (WANs) will benefit from the virtual distributed file system 100 as well. File transfers can be highly optimized on WANs, which often have a high propagation delay, lower and more costly bandwidths, and are often less reliable. The occasional file request nature of the virtual distributed file system 100 works well with WANs, so that an organization is able to have a centralized software server that supports a large number of distributed users.

Although relatively small amounts of data are transferred through the network, additional measures are taken to prevent delays and ensure user performance and experience. Technologies including but not limited to compressed data, sliding cyclic redundancy code (CRC) data replication, and pre-seeded files are used to enhance performance. Standard compression techniques reduce most program files by about half the size. In turn, this effectively doubles the speed of transferring software modules over a network. For example, the main software module for a current version of Microsoft® Word is 8.6 megabytes (MB). However, when compressed that same software module is 4.5 MB. Sliding CRC technology is utilized when transferring a new file to replace an older file. The technology merges the old data target with the new data source, and only transfers the changed information. Only a net change transfer is required, and only the net change data is transferred over the network, which allows for patching software quickly. During the initial installation of Virtual Application Management software, a group of common files can be added to the local file system. These common files would then be available locally when needed, instead of transferring these modules from the remote source. There are common software modules that are used by many applications which would benefit from pre-seeding. A company which has a standard set of applications could utilize such an approach.

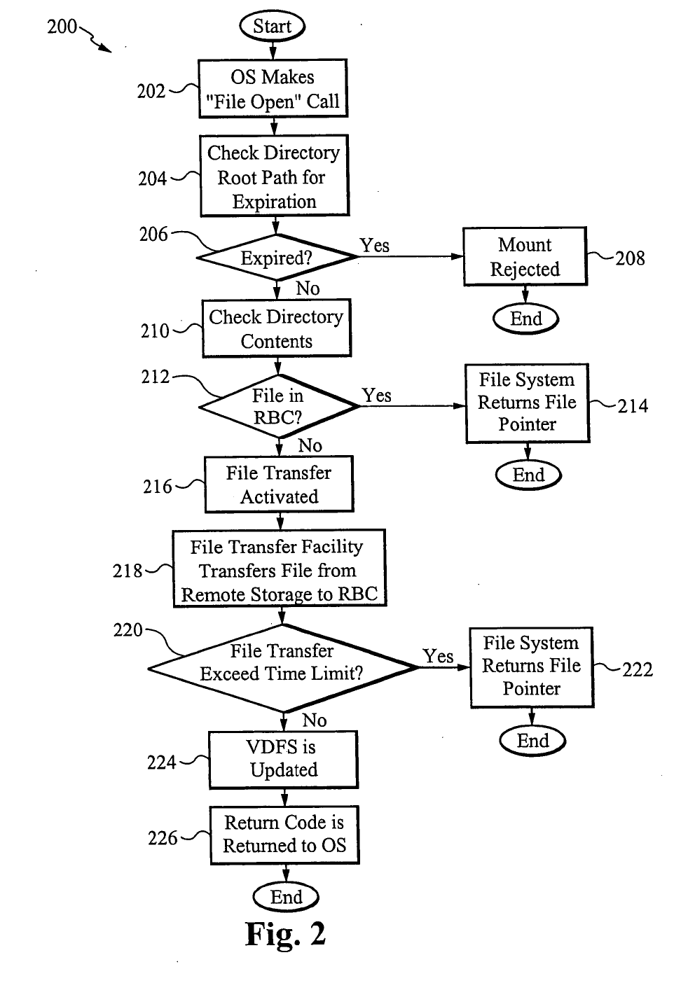

FIG. 2 illustrates a flowchart showing an algorithm 200 for local storage mapping of the preferred embodiment of the present invention. Initially, in step 202, the operating system (OS) makes a “file open” call to a specific file path. In step 204, the file system drivers check the directory root path for an expiration time/date. If it is determine that the current time/date is beyond the directory expiration time/date, in step 206, the mount operation is rejected in step 208. Such a check allows central server administration of software licensing and access. If the current time/date has not expired, then in step 210, the file system drivers check the “directory” contents of the specific file as to the file's physical existence within the Ring Buffer Cache (RBC). If the file exists in the RBC, in step 212, the file system returns the file pointer of the file within the RBC in step 214. If the file does not exist in the RBC, the “file transfer” facility is activated, and the OS file open process is suspended in step 214. Then, in step 216 the “file transfer” facility transfers the file from the remote storage servers to the local RBC storage area. If the file transfer process exceeds the time limit threshold in step 220, then the virtual distributed file system returns an open failure status code back to the local OS in step 222. If the file transfer process completes before the time limit expires, then when the file transfer is complete, the virtual distributed file system directory is updated with the file status and properties including the file CRC, in step 224. Finally, in step 226, a success return code with the file pointer from the RBC is returned to the OS file open call.

The virtual distributed file system takes advantage of software architectures of most applications where a large application is segmented into multiple program modules. The modules are called shared libraries on Unix/Linux systems and dynamic linked libraries (DLLs) on Microsoft® Windows® systems. The modules are only accessed when needed by the application. Many modules are never accessed when running an application since every software utility or feature is typically not accessed.

A similar technique is used for managing operating system memory, known as Virtual Memory, where active memory blocks are mapped to physical memory, and less active or inactive blocks of memory are mapped to slower and less expensive disk storage.

An example of the virtual distributed file system's efficiency is demonstrated with the Microsoft® Office™ application. An installation of Microsoft® Office 2000™ contains 416 files, stored in 16 folders, requiring 116 MB of storage. Typically the “main” program module is run which controls most of the application and then smaller modules are called as needed. When executing Microsoft® Word and Microsoft® Excel of Microsoft® Office™, 14 modules of the 416 files were accessed. The virtual distributed file system created a 98% file access efficiency over a network file system.

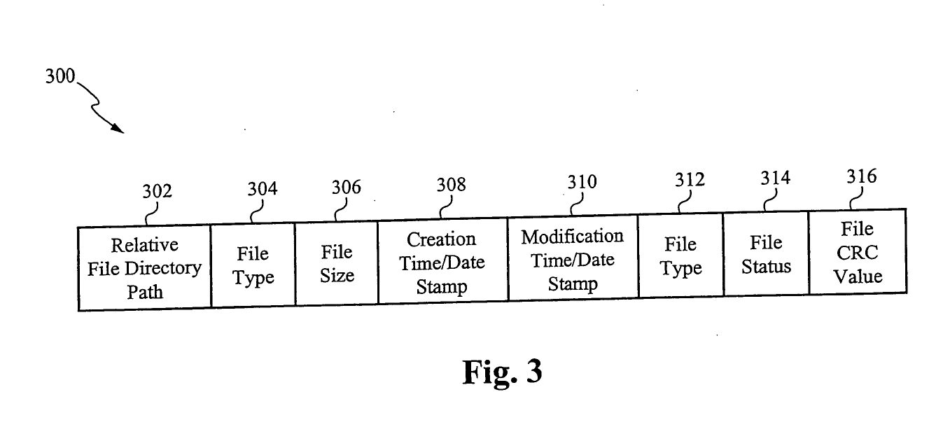

FIG. 3 illustrates a graphical representation of a local directory data structure 300 of the preferred embodiment of the present invention. The virtual distributed file system physical directory structure contains a directory data structure similar to other operating structures. The structure is generated on the local system from the physical structure on the remote system when the remote system is initially accessed. The local directory structure 300 appears to the operating system as a local file system which is accomplished using proprietary file system drivers.

The local directory data structure 300 maintains a hierarchical path structure, similar to most standard operating system file directories, and also maintains a link or pointer to the remote file system when the local file does not exist. The file system contains place holders which the computing device believes to be the actual files but are actually links to the files located on the remote system which are transferred locally when requested. The file pointer maintains and returns to the operating system the file characteristics and statistics of the remote file to the local operating system driver, but only performs a data transfer from the remote system when a file system open call is requested for the local file. The local file pointer is replaced with a copy of the remote file, and the open call continues.

There are a number of attributes included in the local directory data structure 300. A relative file directory path attribute 302 stores the location of the directory. A first file type attribute 304 specifies whether the structure is a folder, file or link. A file size attribute 306 stores the size of the file. A creation time/date stamp attribute 308 holds the time and date when the file was created. A modification time/date stamp attribute 310 specifies the time and date when the file was most recently modified. A second file type attribute 312 stores information similar to a mime type attribute. A file status attribute 314 holds information about the status of the file which is available in the local RBC. A file CRC value attribute 316 is also included in the structure.

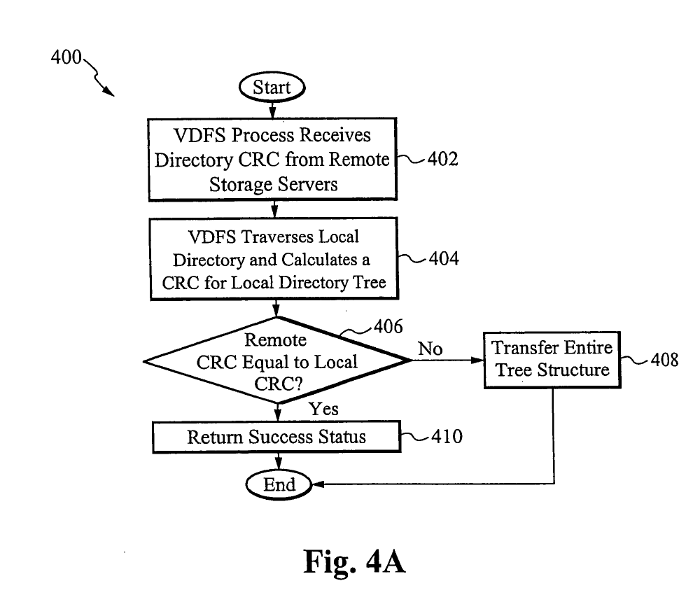

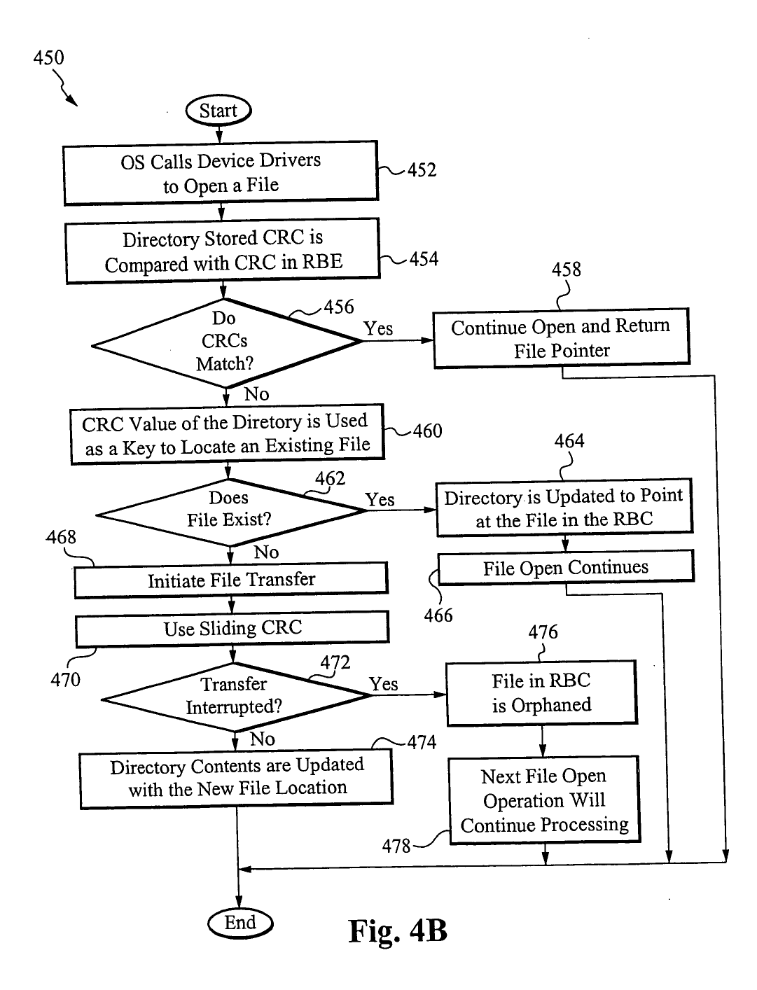

FIG. 4a illustrates a flowchart showing the algorithm for a synchronization protocol of mounting a file system 400 of the preferred embodiment of the present invention. In step 402, the local virtual distributed file system (VDFS) process receives the directory CRC from the remote storage servers. In step 404, the VDFS traverses the local directory and calculates a CRC value for the local directory tree. In step 406, if the remote CRC does match the local CRC, the VDFS process returns a Success status to the Mount File System call from the local OS in step 410. If the CRCs do not match, the entire directory tree structure is transferred from the remote storage servers, and the local directory physical structure is replaced by the remote directory structure in step 408. Each time the remote system is mounted by the client, comparing a CRC of the remote directory with the CRC of the local directory compares the remote file directory for any changes against the local client version. The CRC is created when the file systems are updated, so the comparison is quick and efficient. The CRC will identify if any file within the remote directory is different than the local copy.

FIG. 4b illustrates a flowchart showing the algorithm for a synchronization protocol 450 of opening a file of the preferred embodiment of the present invention. In step 452, the OS calls the device drivers to open a file. In step 454, a directory stored CRC value of the file is compared with the actual file CRC inside the Ring Buffer Cache (RBC). In step 456, if the file CRC matches the directory CRC, the open operation continues normally and the file pointer is returned to the operating system file open call, in step 458. If the file CRC does not match the directory CRC, the CRC value of the directory is used as a key for the RBC to locate an existing file with the exact contents of the requested file, in step 460. In step 462, if a file exists with the correct CRC, the directory is updated to point at the file existing in the RBC in step 464, and the file open continues in step 466. If no matching file exists, then a file transfer is initiated in step 468. The existing file path is passed to the file transfer process to make use of a “Sliding CRC” in step 470. If the file transfer process is interrupted in step 472, the file in the RBC is orphaned in step 476, and the next file open operation will continue processing, using the unchanged directory CRC information in step 478. If the file transfer process is not interrupted in step 472, when the file process is complete, the directory contents are updated with the new file location in step 474.

Local files within the directory, but stored in the RBC, can become orphaned if the directory entry of the file is removed, but the file remains in the RBC until the file is expelled via other mechanisms. The comparison of the local directory with the remote directory is an efficient operation. The remote directory attributes are exported to a textual format, with attributes of each file as: “file path,” “file modification date” and “file CRC.” The textual data is then used to calculate a directory CRC. The CRC value is transferred from the remote storage server, and compared with the local generated directory CRC, calculated in exactly the same manner.

When the directory CRC values do not match, the directory structure is downloaded from the remote storage server and a new directory structure generated, replacing completely the local directory data structure.

On file access, when a file CRC does not match the local file CRC, an updated copy of the file is transferred to the local Ring Buffer Cache, replacing the existing copy.

Updated or replacement file transfers only occur when initiated by directory CRC updates. When a file is transferred during an already existing mount session, the version of the file existing when the directory was opened and mounted on the remote server is transferred. This procedure is to maintain file and directory version synchronization.

The technique of file synchronization would be ineffective with file systems that are in motion and are updated constantly. The technique takes advantage of the static nature of software code directories, and the random access nature of access of software modules, reducing the impact of software upgrades on user access and performance. Program module updates to user code bases are spread out based on software usage and software module access requirements.

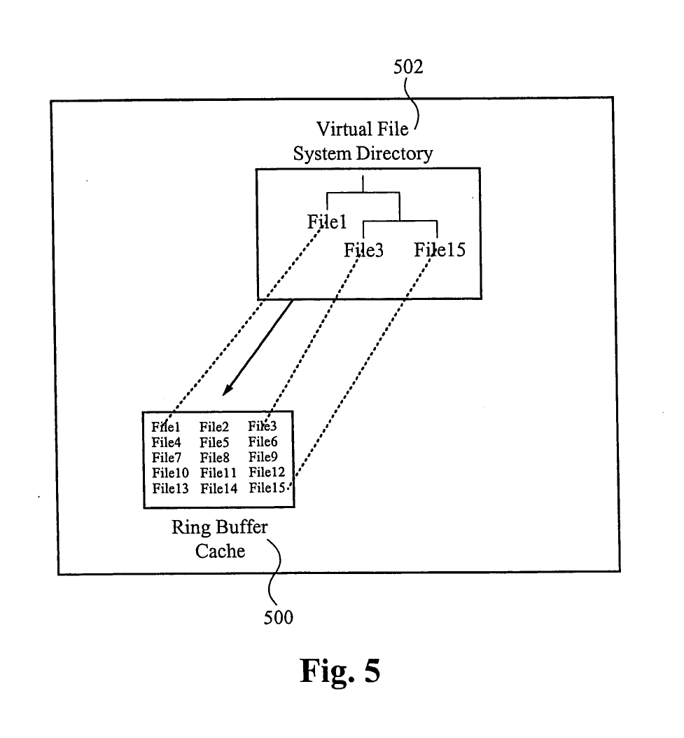

FIG. 5 illustrates a graphical representation of a virtual distributed file system (VDFS) directory 502 and a ring buffer cache (RBC) 500 of the preferred embodiment of the present invention.

The RBC 500 is a semi-permanent storage location for files. The data in the RBC 500 remains until expired by the central storage expiration time/date stamp, or until the data is pushed out by newer data when a size limit is placed on the RBC 500.

The VDFS has two major data structures, the local physical directory structure, and the RBC. The RBC has the function of storage of actual files, indexed by the local VDFS directory 502 structure.

The RBC 500 is a data structure, where the least active data files are removed when the amount of data stored surpasses the preset buffer size limit. This structure optimizes the usage of network bandwidth between the local system and the remote file storage servers.

The RBC 500 contents are index searchable by both the full directory path, and by the CRC value. Retrieving files by the CRC values allows the access and retrieval of duplicate files available locally instead of transferring the files from the remote site, thereby increasing network efficiency. Duplicators of files can occur when a system is either used by more than a single user, when there are common modules between software applications or application version, or when the RBC 500 has been pre-seeded with common program modules.

Data integrity and synchronization between the local directory data structure and the RBC 500 is not critical since the directory is the master source, and orphaned files inside the RBC 500 is a natural occurrence and not problematic. The directory data structure is organized within its own structure to maintain integrity.

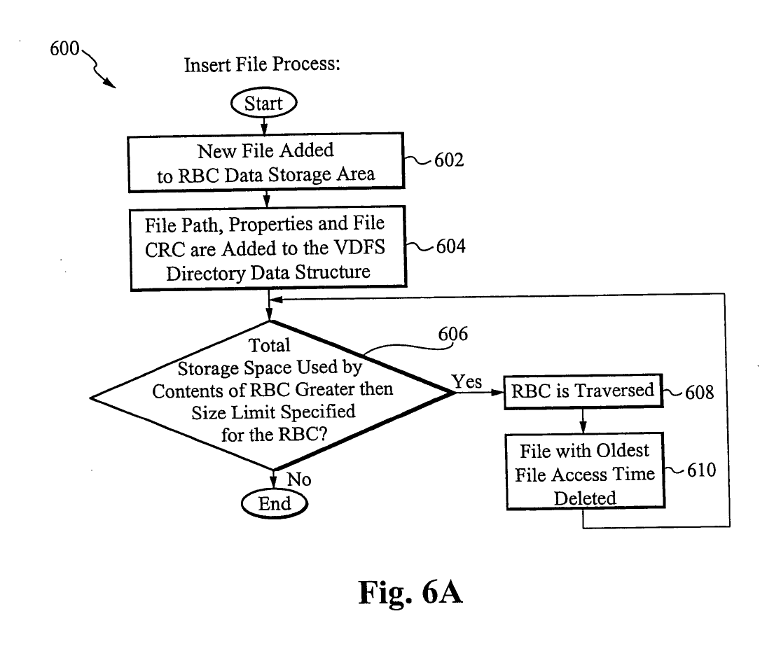

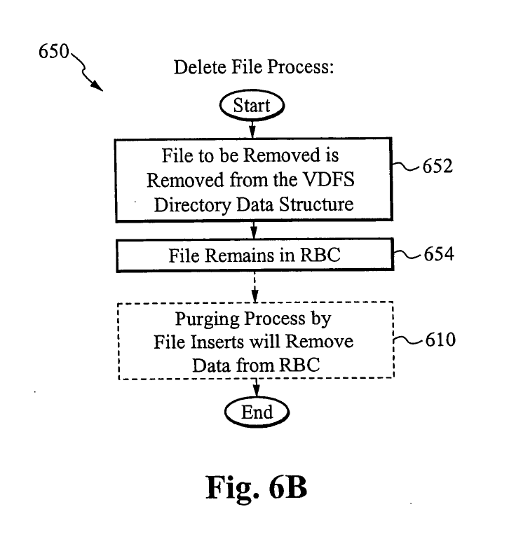

FIG. 6a illustrates a flowchart showing an algorithm 600 for inserting a file into a Ring Buffer Cache (RBC) of the preferred embodiment of the present invention. In step 602, a new file is added to the RBC data storage area. In step 604, a file path, properties and a file CRC are added to the VDFS directory data structure. If the total storage space used by the contents of the RBC is greater than the size limit specified for the RBC in step 606, the RBC is traversed in step 608, and the file with the oldest file access time/date is deleted in step 610. If the total storage space is still greater than the space limit, step 606 is repeated until the total space is below the limit.

FIG. 6b illustrates a flowchart showing an algorithm 650 for deleting a file from a ring buffer cache of the preferred embodiment of the present invention. In step 652, the file to be removed is removed from the VDFS directory data structure. In step 654, the file remains in the RBC until the purging process caused by File Inserts of step 610 is performed, which removes data from the RBC.

A number of technologies are utilized for increased performance of data transfer of the VDFS including compression, seeding, Sliding CRC and Pipelining.

Standard software executable files are candidates for compression algorithms. Microsoft® Windows® binary modules compress about fifty percent, which effectively doubles the network bandwidth utilization. One compression technique is the standard LZM compression used by ZIP and Windows utilities embedded inside both Microsoft® Windows® and Unix/Linux operating systems. Files remain compressed when stored inside the RBC to increase the storage capacity and reduce the necessary size of the RBC, using any one or more appropriate compression techniques.

The RBC increases the efficiency and speed of the Virtual Application System since data file modules cached locally do not need to be transferred from the remote system which would tax the network and central server resources. By pre-loading, or seeding, the RBC with commonly used files, those files will not need to be transferred, but rather will always be available and can be pulled and used from the RBC.

Sliding CRC is a method of transferring a file update over a network. The algorithm compares the source and target files, and then transfers only the net change data. The amount of data transferred over a network is thereby substantially reduced.

When applications are initiated, they typically load the main executable module, and then link in other modules as needed. Pipelining is the process of pre-processing future tasks and pre-loading modules before they are required which increases the speed of a process by pre-processing operations coming down the pipeline. The VDFS has a data structure of software modules associated with each application, where the data structure has stored knowledge of common modules used by an application. In the case when an application is initiated, the VDFS checks that the commonly executed modules exist in the RBC, and when the module is absent, the VDFS initiates the transfer of the module from the remote site before the module is required by the application. Often the module exists in the RBC before the application initiates a module access.

A server process records historical statistics of module transfers shortly after the application “main” executable is transferred. With multiple application initiation transfers complete, accurate statistics are gathered for associated application modules commonly used in conjunction with “main” application modules. For example: when application “main” winword.exe is requested, the following modules are soon requested: wedm01.dll—100%, wnspl.dll—98%, winx.dll—92%, will01.dll 81% . . . . The first file subsequently requested after winword.exe is wedm01.dll since it is extremely likely that it will be needed. When the wedm01.dll module transfer is complete, the VDFS requests other modules such as wnspl.dll, winx.dll, will01.dll and preferably every other module that has a request rate over 75%. The preferred request rate is 75% although it can be modified as needed. For instance, if a network has low bandwidth with generally heavy traffic it would be best to raise the request rate requirement, so that fewer possibly unneeded modules would clog up traffic which could prevent every user from running a smooth and efficient system. However, if the network has a very high bandwidth and little congestion, the request rate could be lowered, so that additional modules are transferred locally and when one of the lesser used modules is required, it is already there, speeding up performance for the user.

An additional feature of the present invention includes offline operation. Software applications have the ability to run disconnected form the central server and network. Either specific components are installed on the local machine whereby any features not installed are inaccessible to the user while offline, or a full install is achievable whereby the full application is installed and the entire application package is accessible while disconnected from the network. Special preparations must be taken for proper offline functionality to ensure that required licenses and subscriptions are abided by.

With respect to subscriptions, the VDFS supports storage limits or quotas, and interfaces for activity and storage usage for billing support. The system supports subscription licenses, so that when the subscription is void or expired, the desktop software becomes disabled and inactive.

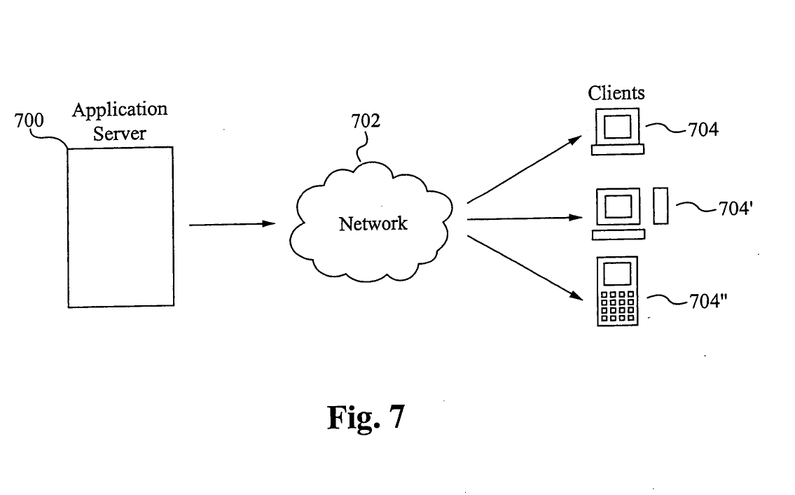

FIG. 7 illustrates a graphical representation of physical components of a virtual distributed file system of the preferred embodiment of the present invention. An application server 700 stores one or more applications which are transferrable to any client which requests them. An application server 700 is any computing device with capabilities to couple to a network 702 and distribute information quickly and efficiently to a number of client computing devices. The network 702 is a standard network which utilizes dial-up, DSL, ethernet, or other similar technologies along with the necessary supporting components such as hubs, routers, and switches and functions similar to an intranet or the Internet. Ultimately, clients which include but are not limited to thin clients 704, personal computers 704′ and PDAs 704″, are coupled to the application server 700 by the network 702. As described above, the clients retrieve application data from the application server 700 when needed, either for updates to applications already contained within the client or to initialize a new application.

In operation, a client mounts the virtual file system which transfers a copy of the directory structure from the application server to the client. When the client initializes an application, it first searches locally in the RBC. If the application is found locally, the file system returns the location of the application in the RBC. However, if the application is not local, the client requests the application from the application server which transfers the application in separate modules beginning with the “main” module. The “main” module is transferred first so that the application begins running as quickly as possible. Afterwards, other required modules and likely useful modules are also transferred, so that they will be available when needed. Most of the modules of an application remain on the application server to be transferred at a later time only when requested. When the modules are transferred from the application server to the client, they are sent to the RBC which retains the most recently used modules. When the RBC is filled, it releases the least recently accessed modules to permit retention of presently required modules. With the required application modules transferred locally to the client, the application runs as a local application.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

1. A system for locally executing one or more applications transferred from a remote location comprising:
a. an application server for remotely storing the one or more applications; and
b. a computing device containing:
i. a first operating system for executing the one or more applications;
ii. a communications interface configured for communicating with the application server;
iii. a first virtual file system mapped to a remote file system located on the application server; and
iv. a ring buffer cache for storing one or more modules of the one or more applications on the computing device.

2. The system as claimed in claim 1 wherein the computing device is from a group consisting of a thin client, personal computer, laptop, PDA or a consumer electronic device.

3. The system as claimed in claim 1 wherein the one or more applications are segmented into one or more compressed modules.

4. The system as claimed in claim 1 wherein a main module of the one or more applications is transferred so that the application is executable nearly immediately, followed by one or more compressed modules related to the main module.

5. The system as claimed in claim 4 wherein a determination of the one or more compressed modules related to the main module is determined by statistical approximations or on demand.

6. The system as claimed in claim 1 wherein the computing device is usable either online or offline a network.

7. The system as claimed in claim 1 wherein the one or more applications are fully installed for offline functionality.

8. The system as claimed in claim 1 further comprising a movable profile whereby a second virtual file system is accessible from a plurality of computing devices by a user.

9. The system as claimed in claim 1 further comprising licensing and subscription capabilities.

10. The system as claimed in claim 1 wherein the application server contains a second operating system which is different from the first operating system contained in the computing device.

11. The system as claimed in claim 1 wherein the one or more applications are updated using sliding cyclic redundancy code (CRC) transfer protocol.

12. The system as claimed in claim 1 wherein the ring buffer cache is pre-seeded with one or more compressed modules.

13. The system as claimed in claim 1 wherein pipelining is utilized to transfer the one or more applications.

14. The system as claimed in claim 1 wherein the first operating system contained in the computing device communicates with the first virtual file system as if the first virtual file system were a local storage device.

15. The system as claimed in claim 1 wherein the first operating system retrieves one or more modules from the first virtual file system by either determining that the one or more modules is present locally or by requesting a transfer of the one or more modules from the application server.

16. The system as claimed in claim 1 further comprising a network for coupling the application server to the computing device, and the network for transferring the one or more applications from the application server to the computing device.

17. A system for locally executing one or more applications transferred from a remote location comprising:
a. an application server for remotely storing the one or more applications; and
b. a computing device containing:
i. a first operating system for executing the one or more applications while online or offline;
ii. a communications interface configured for communicating with the application server;
iii. a first virtual file system mapped to a remote file system located on the application server; and
iv. a ring buffer cache for storing the one or more applications on the computing device;
wherein the application server maintains a movable profile corresponding to a user, and further wherein the moving profile is accessible from a plurality of remote computing devices.

18. The system as claimed in claim 17 wherein the computing device is from a group consisting of a thin client, personal computer, laptop, PDA or a consumer electronic device.

19. The system as claimed in claim 17 wherein the one or more applications are fully installed for offline functionality.

20. The system as claimed in claim 17 further comprising licensing and subscription capabilities.

21. The system as claimed in claim 17 wherein the application server contains a second operating system which is different from the first operating system contained in the computing device.

22. The system as claimed in claim 17 wherein the one or more applications are updated using sliding CRC transfer protocol.

23. The system as claimed in claim 17 wherein the ring buffer cache is pre-seeded with a second set of one or more compressed modules.

24. The system as claimed in claim 17 wherein pipelining is utilized to transfer the one or more applications.

25. The system as claimed in claim 17 wherein the first operating system located on the computing device communicates with the first virtual file system as if the first virtual file system were a local storage device.

26. The system as claimed in claim 17 wherein the first operating system retrieves one or more modules from the first virtual file system by either determining that the one or more modules is present locally or by requesting a transfer of the one or more modules from the application server.

27. The system as claimed in claim 17 further comprising a network for coupling the application server to the computing device, and the network for transferring the one or more applications segmented into a first set of one or more compressed modules from the application server to the computing device, further wherein a main module is transferred so that the application is executable nearly immediately, followed by the first set of modules related to the main module.

28. A method of locally executing one or more applications transferred from a remote location comprising:
a. storing the one or more applications on an application server;
b. mapping a first virtual file system located on a computing device to a remote file system located on the application server;
c. storing one or more modules of the one or more applications in a ring buffer cache on the computing device; and
d. executing the one or more applications on the computing device containing a first operating system.

29. The method as claimed in claim 28 wherein the computing device is from a group consisting of a thin client, personal computer, laptop, PDA or a consumer electronic device.

30. The method as claimed in claim 28 wherein the one or more applications are segmented into one or more compressed modules.

31. The method as claimed in claim 28 wherein a main module of the one or more applications is transferred so that the application is executable nearly immediately, followed by one or more compressed modules related to the main module.

32. The method as claimed in claim 31 wherein a determination of the one or more compressed modules related to the main module is determined by statistical approximations or on demand.

33. The method as claimed in claim 28 wherein the computing device is usable either online or offline a network.

34. The method as claimed in claim 28 wherein the one or more applications are fully installed for offline functionality.

35. The method as claimed in claim 28 further comprising accessing a second virtual file system from a plurality of computing devices by a user with a movable profile.

36. The method as claimed in claim 28 further comprising licensing and subscription capabilities.

37. The method as claimed in claim 28 wherein the application server contains a second operating system which is different from the first operating system contained in the computing device.

38. The method as claimed in claim 28 further comprising updating the one or more applications using sliding cyclic redundancy code (CRC) transfer protocol.

39. The method as claimed in claim 28 further comprising pre-seeding the ring buffer cache with one or more compressed modules.

40. The method as claimed in claim 28 further comprising pipelining to transfer the one or more applications.

41. The method as claimed in claim 28 wherein the first operating system contained in the computing device communicates with the first virtual file system as if the first virtual file system were a local storage device.

42. The method as claimed in claim 28 wherein the first operating system retrieves the one or more modules from the first virtual file system by either determining that the one or more modules is present locally or by requesting a transfer of the one or more modules from the application server.

43. The method as claimed in claim 28 further comprising transferring the one or more applications from the application server to the computing device through a network which couples the application server to the computing device.

44. The method as claimed in claim 28 further comprising transferring the one or more modules from the application server to the ring buffer cache.

45. A method of locally executing one or more applications transferred from a remote location comprising:
a. remotely storing the one or more applications on an application server;
b. mapping a first virtual file system located on a computing device to a remote file system located on the application server;
c. storing one or more modules of the one or more applications in a ring buffer cache on the computing device;
d. executing the one or more applications on the computing device containing a first operating system while online or offline the network; and
e. establishing a movable profile corresponding to a user, which is accessible from a plurality of remote computing devices.

46. The method as claimed in claim 45 wherein the computing device is from a group consisting of a thin client, personal computer, laptop, PDA or a consumer electronic device.

47. The method as claimed in claim 45 wherein the one or more applications are fully installed for offline functionality.

48. The method as claimed in claim 45 further comprising licensing and subscription capabilities.

49. The method as claimed in claim 45 wherein the application server contains a second operating system which is different from the first operating system contained in the computing device.

50. The method as claimed in claim 45 further comprising updating the one or more applications using sliding CRC transfer protocol.

51. The method as claimed in claim 45 further comprising pre-seeding the ring buffer cache with one or more compressed modules.

52. The method as claimed in claim 45 further comprising pipelining to transfer the one or more applications.

53. The method as claimed in claim 45 wherein the first operating system located on the computing device communicates with the first virtual file system as if the first virtual file system were a local storage device.

54. The method as claimed in claim 45 wherein the first operating system retrieves the one or more modules from the first virtual file system by either determining that the one or more modules is present locally or by requesting a transfer of the one or more modules from the application server.

55. The method as claimed in claim 45 further comprising transferring the one or more applications segmented into a first set of one or more compressed modules from the application server to the computing device through a network which couples the application server to the computing device, further transferring a main module so that the application is executable nearly immediately, followed by the first set of modules related to the main module.

56. The method as claimed in claim 45 further comprising transferring the one or more modules from the application server to the ring buffer cache.

57. A method of locally executing an application transferred from a remote location comprising:
a. remotely storing the application on an application server;
b. mapping a first virtual file system located on a computing device to a remote file system located on the application server;
c. determining if one or more modules of the application are located within a ring buffer cache;
d. retrieving the one or more modules from the ring buffer cache if it is determined that the one or more modules are located within the ring buffer cache;
e. transferring the one or more modules from the application server to the computing device, and storing the one or more modules in the ring buffer cache on the computing device if it is determined that the one or more modules are not located within the ring buffer cache;
f. executing the application on the computing device containing a first operating system while online or offline the network; and
g. establishing a movable profile corresponding to a user, which is accessible from a plurality of remote computing devices.

58. The method as claimed in claim 57 wherein the computing device is from a group consisting of a thin client, personal computer, laptop, PDA or a consumer electronic device.

59. The method as claimed in claim 57 wherein the application is fully installed for offline functionality.

60. The method as claimed in claim 57 further comprising licensing and subscription capabilities.

61. The method as claimed in claim 57 wherein the application server contains a second operating system which is different from the first operating system contained in the computing device.

62. The method as claimed in claim 57 further comprising updating the application using sliding CRC transfer protocol.

63. The method as claimed in claim 57 further comprising pre-seeding the ring buffer cache with one or more compressed modules.

64. The method as claimed in claim 57 further comprising pipelining to transfer the one or more modules.

65. The method as claimed in claim 57 wherein the first operating system located on the computing device communicates with the first virtual file system as if the first virtual file system were a local storage device.

66. The method as claimed in claim 57 wherein the transferring occurs through a network.

67. The method as claimed in claim 57 wherein the application is segmented into a first set of one or more compressed modules.

68. The method as claimed in claim 57 further comprising transferring a main module so that the application is executable nearly immediately followed by a first set of modules related to the main module.

69. An apparatus for storing one or more applications on a remote location comprising:
a. a server for distributing the one or more applications as one or more compressed modules to one or more remote computing devices, wherein the server automatically updates the one or more applications on the one or more computing devices; and
b. a file system located on the server for mapping to a virtual file system on the one or more computing devices with a ring buffer cache wherein the one or more computing devices retrieve one or more compressed modules from the server only as necessary.

70. The apparatus as claimed in claim 69 wherein the one or more computing devices are from a group consisting of a thin client, personal computer, laptop, PDA or a consumer electronic device.

71. The apparatus as claimed in claim 69 further comprising licensing and subscription capabilities.

72. The apparatus as claimed in claim 69 wherein the application server contains a first operating system which is different from a second operating system contained in the computing device.

73. The apparatus as claimed in claim 69 wherein the one or more applications are updated using sliding CRC transfer protocol.

74. The apparatus as claimed in claim 69 wherein pipelining is utilized to transfer the one or more applications.

75. An apparatus for retrieving an application from a remote location comprising:
a. a computing device;
b. a first operating system for executing the application;
c. a first virtual file system stored on the computing device for mapping to a remote file system stored on an application server wherein the remote file system contains an original copy of the application; and
d. a ring buffer cache for storing one or more modules of the application.

76. The apparatus as claimed in claim 75 wherein the computing device is from a group consisting of a thin client, personal computer, laptop, PDA or a consumer electronic device.

77. The apparatus as claimed in claim 75 wherein the application is segmented into one or more compressed modules.

78. The apparatus as claimed in claim 75 wherein the computing device is usable either online or offline a network.

79. The apparatus as claimed in claim 75 wherein the application is fully installed for offline functionality.

80. The apparatus as claimed in claim 75 further comprising a movable profile whereby a second virtual file system is accessible from a plurality of computing devices by a user.

81. The apparatus as claimed in claim 75 further comprising licensing and subscription capabilities.

82. The apparatus as claimed in claim 75 wherein the application server contains a second operating system which is different from the first operating system contained in the computing device.

83. The apparatus as claimed in claim 75 wherein the application is updated using sliding cyclic redundancy code (CRC) transfer protocol.

84. The apparatus as claimed in claim 75 wherein the ring buffer cache is pre-seeded with one or more compressed modules.

85. The apparatus as claimed in claim 75 wherein pipelining is utilized to transfer the application.

86. The apparatus as claimed in claim 75 wherein the first operating system contained in the computing device communicates with the first virtual file system as if the first virtual file system were a local storage device.

87. The apparatus as claimed in claim 75 wherein the first operating system retrieves one or more modules from the first virtual file system by either determining that the one or more modules is present locally or by requesting a transfer of the one or more modules from the application server.

88. The apparatus as claimed in claim 75 further comprising a network for coupling the application server to the computing device, wherein the network transfers the application from the application server to the computing device.

89. A data structure for storing one or more applications retrieved from a remote location, wherein the one or more applications are indexed by a local file system, and further wherein the data structure removes the least active files when a buffer size limit is surpassed and the data structure is index searchable.

90. The structure as claimed in claim 89 wherein the one or more applications are segmented into one or more compressed modules.

91. The structure as claimed in claim 89 wherein the structure is index searchable by a full directory path or by a CRC value.

92. The structure as claimed in claim 89 wherein the structure is pre-seeded with the one or more applications.
